(19) United States
(12) Patent Application Publication
(10) Pub. No.: US 2025/0310285 A1
(43) Pub. Date: Oct. 2, 2025

(54) HUMAN-COMPUTER INTERACTION METHOD AND APPARATUS BASED ON HISTORICAL CONVERSATION, DEVICE AND STORAGE MEDIUM

(71) Applicant: Beijing Baidu Netcom Science Technology Co., Ltd., Beijing (CN)

(72) Inventor: Guangyuan YAN, Beijing (CN)

(21) Appl. No.: 19/235,878

(22) Filed: Jun. 12, 2025

(30) Foreign Application Priority Data
Jul. 31, 2024 (CN) 202411046432.6

(51) Int. Cl. H04L 51/02; G06F 16/335; G06F 40/30; H04L 51/216

(52) U.S. Cl. CPC H04L 51/02; G06F 16/335; G06F 40/30; H04L 51/216

(57) ABSTRACT

The present disclosure provides a human-computer interaction method and apparatus based on a historical conversation, a device, and a storage medium, relates to the field of artificial intelligence, in particular to the field of human-computer interaction. The specific implementation solution is: acquiring current conversation information of a user and a historical conversation database; where the historical conversation database includes a plurality of historical memory objects, the historical memory object represents the historical conversation information of the user and an analysis result of the historical conversation information, the analysis result includes a timestamp and semantic information of the historical conversation information; determining, from the historical conversation database, a historical memory object associated with the current conversation information as a target memory object; determining, according to the target memory object, response information of the current conversation information.

### CROSS-REFERENCE TO RELATED APPLICATION

This application claims priority to Chinese Patent Application No. 202411046432.6, filed on Jul. 31, 2024, which is hereby incorporated by reference in its entirety.

### TECHNICAL FIELD

The present disclosure relates to the field of human-computer interaction in the field of artificial intelligence and, in particular, relates to a human-computer interaction method and apparatus based on a historical conversation, a device, and a storage medium.

### BACKGROUND

With the development of artificial intelligence technologies, a user has a higher and higher requirement for interactive experience during human-computer interaction. The user can automatically obtain a response to a piece of information by inputting the piece of information according to needs.

The user expects to obtain accurate response information when interacting with a computer. How to provide the user with an efficient and accurate response is an urgent problem that needs to be solved.

### SUMMARY

The present disclosure provides a human-computer interaction method and apparatus based on a historical conversation, a device, and a storage medium.

According to a first aspect of the present disclosure, a human-computer interaction method based on a historical conversation is provided, including:
acquiring current conversation information of a user and a historical conversation database; where the historical conversation database includes a plurality of historical memory objects, the historical memory object represents historical conversation information of the user and an analysis result of the historical conversation information, the analysis result includes a timestamp and semantic information of the historical conversation information;
determining, from the historical conversation database, a historical memory object associated with the current conversation information as a target memory object;
determining, according to the target memory object, response information of the current conversation information.

According to a second aspect of the present disclosure, a human-computer interaction apparatus based on a historical conversation is provided, including:
at least one processor; and
a memory communicatively connected to the at least one processor;
where the memory stores instructions that are executed by the at least one processor, and the instructions are executed by the at least one processor to cause the at least one processor to:
acquire current conversation information of a user and a historical conversation database; where the historical conversation database includes a plurality of historical memory objects, the historical memory object represents historical conversation information of the user and an analysis result of the historical conversation information, the analysis result includes a timestamp and semantic information of the historical conversation information;
determine, from the historical conversation database, a historical memory object associated with the current conversation information as a target memory object;
determine, according to the target memory object, response information of the current conversation information.

According to a fourth aspect of the present disclosure, a non-transitory computer readable storage medium having computer instructions stored therein is provided, where the computer instructions are used to cause a computer to:
acquire current conversation information of a user and a historical conversation database; where the historical conversation database includes a plurality of historical memory objects, the historical memory object represents historical conversation information of the user and an analysis result of the historical conversation information, the analysis result includes a timestamp and semantic information of the historical conversation information;
determine, from the historical conversation database, a historical memory object associated with the current conversation information as a target memory object;
determine, according to the target memory object, response information of the current conversation information.

It should be understood that contents described in this section are not intended to identify key or important features of the embodiments of the present disclosure, nor are they intended to limit the scope of the present disclosure. Other features of the present disclosure will be easily understood from the following description.

### BRIEF DESCRIPTION OF THE DRAWINGS

The drawings are used to better understand the present solution, and do not constitute a limitation on the present disclosure. Where:

FIG. 1 is a flow schematic diagram of a human-computer interaction method based on a historical conversation according to an embodiment of the present disclosure.

FIG. 2 is a flow schematic diagram of a human-computer interaction method based on a historical conversation according to an embodiment of the present disclosure.

FIG. 3 is a flow schematic diagram of a human-computer interaction method based on a historical conversation according to an embodiment of the present disclosure.

FIG. 4 is a structural block diagram of a human-computer interaction apparatus based on a historical conversation according to an embodiment of the present disclosure.

FIG. 5 is a structural block diagram of a human-computer interaction apparatus based on a historical conversation according to an embodiment of the present disclosure.

FIG. 6 is a block diagram of an electronic device for implementing a human-computer interaction method based on a historical conversation according to an embodiment of the present disclosure.

FIG. 7 is a block diagram of an electronic device for implementing a human-computer interaction method based on a historical conversation according to an embodiment of the present disclosure.

### DETAILED DESCRIPTION OF THE EMBODIMENTS

Exemplary embodiments of the present disclosure are described below with reference to the accompanying drawings, which include various details of the embodiments of the present disclosure to facilitate understanding, and should be considered as merely exemplary. Therefore, those of ordinary skill in the art should recognize that various changes and modifications can be made to the embodiments described herein without departing from the scope and spirit of the present disclosure. Similarly, for clarity and conciseness, descriptions of well-known functions and structures are omitted in the following description.

A human-computer interaction refers to processing conversation information input by a user and sending corresponding response information to the user. For example, LLM (Large Language Model) may be used to process the conversation information input by the user. In order to reply more accurate information to the user, historical conversation information of the user may usually be combined so that the response information can better meet the user's actual needs.

However, the historical conversation information of the user is usually a long conversation, and models such as LLM have an input length limitation when processing the long conversation, so that it impossible to effectively analyze the historical conversation information. At present, truncation and segmentation and other methods may be used to process the long conversation. Text truncation refers to directly intercepting a part of the historical conversation information as input, and segmentation input refers to segmenting the historical conversation information of the long conversation into a plurality of short sequences and inputting them into the model respectively. However, the text truncation and the segmentation input will lead to information loss, affecting efficiency and accuracy of determining the response information, resulting in low efficiency and accuracy of the human-computer interaction, affecting user's interactive experience.

The present disclosure provides a human-computer interaction method and apparatus based on a historical conversation, a device, and a storage medium, which are applied to human-computer interaction field in the field of artificial intelligence to improve the efficiency and accuracy of the human-computer interaction and improve user experience.

It should be noted that the model in this embodiment is not a model for a certain specific user and cannot reflect personal information of a certain specific user. It should be noted that data in this embodiment comes from a public data set.

In the technical solution of the present disclosure, collection, storage, use, processing, transmission, provision, disclosure and other processings of user personal information involved are in compliance with the provisions of relevant laws and regulations and do not violate public order and good morals.

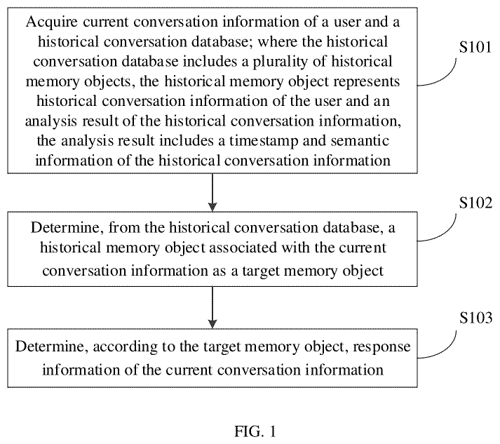

In order to enable readers to have a deeper understanding of the implementation principle of the present disclosure, the embodiments are further detailed in conjunction with the following FIG. 1 to FIG. 7.

FIG. 1 is a flow schematic diagram of a human-computer interaction method based on a historical conversation according to an embodiment of the present disclosure, the method may be executed by a human-computer interaction apparatus based on the historical conversation. As shown in FIG. 1, the method includes the following steps:
S101, acquire current conversation information of a user and a historical conversation database; where the historical conversation database includes a plurality of historical memory objects, the historical memory object represents historical conversation information of the user and an analysis result of the historical conversation information, the analysis result includes a timestamp and semantic information of the historical conversation information.

For example, when performing the human-computer interaction, a user may input the conversation information in real time, and the user may input the conversation information in a form of text or voice. For example, the user may input a question and obtain an answer to the question through the human-computer interaction. The conversation information currently input by the user may be acquired in real time, that is, the current conversation information is acquired. The conversation information of the human-computer interaction performed by the user each time may be stored as new historical conversation information, and the historical conversation information may be stored in a historical conversation database. The conversation information of the human-computer interaction performed by the user may include the conversation information input by the user and the conversation information replied by a robot. The new historical conversation information may be acquired in real time or periodically, and the historical conversation database may be updated.

When acquiring the current conversation information of the user, the historical conversation database may also be acquired. The historical conversation database may include the plurality of historical memory objects, each historical memory object may represent a sentence or a section of historical conversation information, as well as the analysis result of the historical conversation information, and the analysis result may include information such as the timestamp and the semantic information of the historical conversation information. For example, each conversation information that has been sent is used as a piece of historical conversation information, and each piece of historical conversation information corresponds to a historical memory object, and the historical memory object may represent a text content of the piece of historical conversation information. After a piece of historical conversation information is obtained, a sending time of the historical conversation information may be determined, and the sending time may be stored as the timestamp in the historical memory object of the historical conversation information. A semantic analysis may be performed on the historical conversation information to obtain semantic information such as an emotion, a theme, a keyword, etc. expressed by the historical conversation information, the semantic information is also stored in the historical memory object of the historical conversation information. The historical memory object may be referred to as an IMO (Interactive Memory Object). In this embodiment, the processing method of the semantic analysis is not specifically limited.

A data table may be set in the historical conversation database, each row in the data table represents one IMO, and a column in the data table may represent a field stored in the IMO, for example, the field may include the text content, the timestamp, a title, a keyword, a subject category, a sentiment tag, etc. of the historical conversation information. The title may be a summary of a content of the historical conversation information; the keyword is an important phrase in the text content of the historical conversation information; the subject category may be the field involved in the historical conversation information, for example, it may be a subject such as travel, food, etc.; the sentiment tag may represent an emotion expressed by the historical conversation information, for example, it may be a positive emotion or a negative emotion. Each time one IMO is obtained, the IMO is stored in the historical conversation database.

In this embodiment, the method further includes: determining the sending time of the current conversation information, and determining the sending time as the timestamp of the current conversation information; performing the semantic analysis processing on the current conversation information to obtain the semantic information of the current conversation information; determining the timestamp of the current conversation information and the semantic information of the current conversation information as an analysis result of the current conversation information; determining the current conversation information and the analysis result of the current conversation information as a new historical memory object, and storing the new historical memory object in the historical conversation database.

Specifically, after the current conversation information is acquired, the current conversation information may be analyzed to obtain the analysis result of the current conversation information, so that the text content and the analysis result of the current conversation information are stored as a new historical memory object in the historical conversation database. The analysis result may include information such as the timestamp and the semantic information of the conversation information. The determining the sending time of the current conversation information may be, for example, determining a time when the user sends the conversation information, or a time when the robot sends the conversation information. The sending time of the current conversation information is used as the timestamp of the current conversation information, that is, the sending time of each piece of conversation information is marked for the each piece of conversation information.

A semantic analysis algorithm may also be preset to perform a semantic analysis processing on the current conversation information to obtain the semantic information of the current conversation information, the semantic information may include a title, a keyword, a subject category, a sentiment tag, etc. The timestamp of the current conversation information and the semantic information of the current conversation information are determined as the analysis result of the current conversation information. The current conversation information and the analysis result of the current conversation information are determined as a new IMO and stored in the historical conversation database. The IMO may be compressed or encrypted to save storage space and protect data security.

The beneficial effect of such a setting is that when a user conducts human-computer interaction, the new historical memory object may be generated based on a conversation content, the historical conversation database may be automatically updated, so that the accuracy and efficiency of determining the response information can be improved, and user experience can be improved.

In this embodiment, the method further includes: determining, in the historical conversation database, a previous piece of conversation information of the current conversation information; marking a preset logical identifier in the current conversation information and the previous piece of conversation information of the current conversation information; where the preset logical identifier represents that there is a logical structure and a time sequence between two pieces of conversation information.

Specifically, an association relationship may be established between different IMOs to reflect a logical structure and a time sequence of the conversation. For example, a previous sentence and a next sentence may be associated. That is, for each piece of the current conversation information, a previous piece of conversation information of the current conversation information may be determined. A preset logical identifier is marked for these two pieces of conversation information, and a logical identifier may represent that there is the logical structure and the time sequence between the two pieces of conversation information.

In the historical conversation database, the preset logical identifier is added to the two pieces of conversation information. When searching for one piece of the conversation information, another piece of conversation information that is logically associated with the conversation information may be searched according to the logical identifier.

The beneficial effect of such a setting is that by adding the logical identifier, the association relationship between different IMOs may be determined, which facilitates subsequent retrieval and query, thereby improving the efficiency and accuracy of human-computer interaction.

In this embodiment, the method further includes: acquiring, according to a preset information updating period, a timestamp of the historical memory object in the historical conversation database; if it is determined that a storage duration of the historical memory object in the historical conversation database exceeds a preset duration threshold according to the timestamp of the historical memory object, deleting the historical memory object from the historical conversation database.

Specifically, the historical conversation database may be updated regularly. An information updating period is preset, for example, the information updating period may be 24 hours. According to the preset information updating period, the timestamps of all historical memory objects in the historical conversation database are acquired, the timestamp may represent the sending time of the historical conversation information in the historical memory object. For example, the sending time of each piece of the historical conversation information is acquired once every 24 hours.

A current time is determined, and it is determined whether storage duration of the historical memory object in the historical conversation database exceeds a preset duration threshold according to the current time and the timestamp of the historical memory object. For example, if the preset duration threshold is one year, it is determined whether a time difference between the sending time of the historical conversation information and the current time exceeds one year. If it is determined that the storage duration of the historical memory object in the historical conversation database exceeds the preset duration threshold, the historical memory object may be deleted from the historical conversation database; if the storage duration does not exceed the preset duration threshold, the historical memory object is retained in the historical conversation database.

The beneficial effect of such a setting is that a database structure is optimized and system performance is improved by cleaning up obsolete IMOs.

Users may also update the historical conversation database on their own. For example, the users may issue database viewing instructions through manners such as a graphical interface or a voice command to view the IMOs in the historical conversation database in a visual interface. Edition, deleting, and deduplication and other operations may be performed on the IMOs in the historical conversation database. Through manual intervention, a quality of the IMOs may be improved, thereby improving the accuracy and efficiency of subsequent human-computer interactions.
S102, determine, from the historical conversation database, a historical memory object associated with the current conversation information as a target memory object.

For example, the robot needs to respond to the conversation information of the user. When performing a response, the IMO associated with the current conversation information may be found from the historical conversation database as the target memory object. The target memory object may be retrieved according to the context of the current conversation information and the actual needs of the user. For example, the semantic analysis may be performed on the current conversation information to find the IMO with the most similar semantics to the current conversation information as an associated target memory object, or the IMO with the most repeated words in the current conversation information may be found as an associated target memory object.

A determination rule of the target memory object may be preset, for example, the target memory object may be determined according to a matching degree of the subject category, the number of repeated words, a similarity of semantics, etc. In this embodiment, the determination rule of the target memory object is not specifically limited.
S103, determine, according to the target memory object, response information of the current conversation information.

For example, after the target memory object is obtained, the response information of the current conversation information may be determined by combining the target memory object and the current conversation information, and the response information is sent to the user. For example, the response information of the current conversation information may be extracted from the target memory object. An algorithm of an information extraction may be preset, for example, key information may be extracted from the target memory object and then integrated into a complete sentence. In this embodiment, the algorithm of the information extraction is not specifically limited.

The target memory object may be one or more, if a plurality of target memory objects are found, the response information may be determined by combining the plurality of target memory objects. For example, the response information of the current conversation information may be extracted from the plurality of target memory objects respectively, and then the extracted multiple pieces of response information may be integrated into final response information.

In the embodiment of the present disclosure, when a user is performing human-computer interaction, current conversation information and a historical conversation database may be acquired in real time. The historical conversation database may include the plurality of historical memory objects, each historical memory object may represent historical conversation information of the user and a timestamp and semantic information and other analysis results of the historical conversation information. For each piece of historical conversation information, a separate historical memory object is generated for storage. According to the analysis result of the historical memory object, the historical memory object associated with the current conversation information is determined from the historical conversation database as the target memory object. The user is responded to in combination with the target memory object. By generating the historical memory object, an interception of a long historical conversation is reduced, a memory capacity is improved, and historical information related to a current conversation may be retrieved more accurately, thereby improving the accuracy and efficiency of human-computer interaction and improving user's interactive experience.

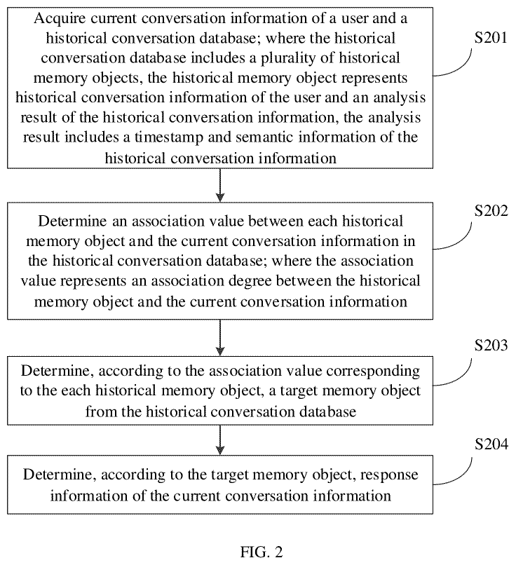

FIG. 2 is a flow schematic diagram of a human-computer interaction method based on a historical conversation according to an embodiment of the present disclosure.

In this embodiment, the determine, from the historical conversation database, a historical memory object associated with current conversation information as a target memory object, includes: determining an association value between each historical memory object and the current conversation information in the historical conversation database; where the association value represents an association degree between the historical memory object and the current conversation information; and determining, according to the association value corresponding to the each historical memory object, the target memory object from the historical conversation database.

As shown in FIG. 2, the method includes the following steps:
S201, acquire the current conversation information of a user and the historical conversation database; where the historical conversation database includes a plurality of historical memory objects, the historical memory object represents the historical conversation information of the user and an analysis result of the historical conversation information, the analysis result includes a timestamp and semantic information of the historical conversation information.

For example, this step may refer to the above-mentioned step S101 and will not be repeated.
S202, determine the association value between the each historical memory object and the current conversation information in the historical conversation database; where the association value represents the association degree between the historical memory object and the current conversation information.

For example, for each IMO in the historical conversation database, the association value between the IMO and the current conversation information is determined, the association value may represent the association degree between the IMO and the current conversation information. The higher the association value, the more the historical conversation information in the IMO matches the current conversation information. For example, if a subject category of the IMO is the same as a subject category of the current conversation information, the association value is high.

In this embodiment, the determine the association value between the each historical memory object and the current conversation information in the historical conversation database includes: determining, according to the timestamp of the historical memory object, a distance value between the historical memory object and the current conversation information; where the distance value represents a time distance between the historical memory object and the current conversation information; determining, according to semantic information of the historical memory object, a correlation value between the historical memory object and the current conversation information; where the correlation value represents a semantic correlation degree between the historical conversation information represented by the historical memory object and the current conversation information; determining, according to the distance value and the correlation value corresponding to the historical memory object, the association value between the historical memory object and the current conversation information.

Specifically, for each IMO, the timestamp of the IMO is determined, that is, a sending time of the IMO is determined. The sending time of the current conversation information is determined, and the distance value between the IMO and the current conversation information is determined according to the timestamp of the IMO and the sending time of the current conversation information. The distance value may represent the time distance between the IMO and the current conversation information. For example, a time difference between the timestamp of the IMO and the sending time of the current conversation information may be determined, and the distance value is determined according to the time difference. The smaller the time difference, the smaller the distance value, that is, the closer the IMO is to the current conversation information.

A semantic analysis is performed on the current conversation information to obtain the semantic information of the current conversation information. The semantic information of the historical memory object is determined, and the correlation value between the historical memory object and the current conversation information is determined according to the semantic information of the historical memory object and the semantic information of the current conversation information. The correlation value may represent the semantic correlation degree between the historical conversation information represented by the historical memory object and the current conversation information. The more similar the semantic of the current conversation information is to the semantic of the historical memory object, the greater the correlation value is. For example, the more similar the subject category of the current conversation information is to the subject category of the historical memory object, the greater the correlation value.

The semantic information may include a title, a keyword, a subject category, a sentiment tag, and other information, and these piece of information may be combined to calculate the correlation value. For example, the title of the current conversation information is matched with the title of the historical memory object to obtain a numerical value of a matching result; the keyword of the current conversation information is matched with the keyword of the historical memory object to obtain another numerical value of a matching result. The two numerical values are added together to obtain the correlation value.

The association value between the historical memory object and the current conversation information is determined by combining the distance value and the correlation value corresponding to the historical memory object. For example, the distance value and the correlation value may be added to obtain the association value; or an average of the distance value and the correlation value may be calculated as the association value.

The beneficial effect of such a setting is that for each IMO, recency and correlation with the current conversation information may be calculated, and the association value may be obtained by combining and calculating the recency and the correlation. The target memory object associated with the current conversation information can be retrieved more accurately, response accuracy can be improved, and user experience can be improved.

In this embodiment, the semantic information includes a sentiment tag, and the sentiment tag represents an emotion expressed by the historical conversation information represented by the historical memory object; the determining, according to the semantic information of the historical memory object, the correlation value between the historical memory object and the current conversation information, includes: performing sentiment analysis on the current conversation information to obtain sentiment information of the current conversation information; determining a similarity between the sentiment information of the current conversation information and the sentiment tag of the historical memory object; and determining, according to the similarity, the correlation value between the historical memory object and the current conversation information.

Specifically, the semantic information may include the sentiment tag, and the sentiment tag may represent the emotion expressed by the historical conversation information represented by the historical memory object. For each IMO, the sentiment tag of the IMO may be acquired, that is, the emotion expressed by the historical conversation information in the IMO may be determined.

A sentiment analysis algorithm is preset to perform the sentiment analysis on the current conversation information to obtain the sentiment information of the current conversation information, that is, to determine the sentiment expressed by the current conversation information. In this embodiment, the sentiment analysis algorithm is not specifically limited.

A similarity determining algorithm is preset to calculate a similarity between the sentiment information of the current conversation information and the sentiment tag of the historical memory object. The similarity may be expressed as a similarity degree between the emotion represented by the current conversation information and the emotion represented by the historical conversation information in the historical memory object. For example, if the sentiment information of the current conversation information represents a positive emotion, and the sentiment tag of the historical memory object also represents a positive emotion, the similarity may be high. In this embodiment, the preset similarity determining algorithm is not specifically limited.

According to the similarity between the sentiment information of the current conversation information and the sentiment tag of the historical memory object, the correlation value between the historical memory object and the current conversation information is determined. The higher the similarity, the higher the correlation value may be. For example, the similarity may be determined as the correlation value.

The beneficial effect of such a setting is that the correlation value is determined based on emotion-related information in the semantic information, so that the target memory object is more matched with the current conversation information, the response information can better conform to a user's current state, determining accuracy of the response information is improved, and the user experience is improved.

In this embodiment, the determining, according to the distance value and the correlation value corresponding to the historical memory object, the association value between the historical memory object and the current conversation information, includes: determining a sentence structure of the historical conversation information represented by the historical memory object; where the sentence structure represents grammar and a word order of the historical conversation information; determining an importance value of the historical memory object according to the sentence structure; where the importance value represents a degree of grammatical fluency and a degree of contextual importance of the historical conversation information represented by the historical memory object; determining, according to the distance value, the correlation value, and the importance value corresponding to the historical memory object, the association value between the historical memory object and the current conversation information.

Specifically, for each IMO, the sentence structure of the historical conversation information represented by the IMO may be determined. The sentence structure may represent the grammar and the word order of the historical conversation information, that is, the grammar used by the historical conversation information and the word order in the sentence may be determined. For example, a subject, a predicate, an object, etc. in the historical conversation information may be determined, and whether the historical conversation information is expressed completely, clearly, and vividly may also be determined. A grammatical structure and the word order may often reveal an importance of information. For example, in many languages, key components such as the subject, the predicate, and the object are usually located at a core of the sentence, while other modifying components such as an attributive and an adverbial may be located at the periphery. The sentence structure may also represent a sentence pattern of the historical conversation information. For example, special sentence patterns such as an emphasis sentence and an inversion sentence are also often used to highlight the importance of the information.

According to the sentence structure, the importance value of the historical memory object may be determined, and the importance value may represent the degree of the grammatical fluency and the degree of the contextual importance of the historical conversation information represented by the historical memory object. Whether the sentence is fluent may be determined according to the grammatical structure. The more fluent the sentence reads, the higher the importance value may be considered. For example, if positions of the subject and the predicate in the historical conversation information are reversed, it may be determined that the importance value is low. The same sentence may have different importance in different contexts. For example, “it will rain tomorrow” may be very important when planning outdoor activities, but may be irrelevant when discussing historical events. That is, the importance value of the historical conversation information may be determined by combining the sentence structure and the context of the historical conversation information.

For each IMO, the distance value, the correlation value and the importance value may be calculated, and these three indicators may be combined and calculated to obtain the association value of the IMO. For example, these three indicators may be added to obtain the final association value.

The beneficial effect of such a setting is that the importance degree of the IMO is determined. The higher the importance degree, the more likely it is to be determined as the target memory object, thereby improving the accuracy of response information and improving user's interactive experience.

In this embodiment, the method further includes: determining the number of occurrences of the historical conversation information represented by the historical memory object in the historical conversation database; and adjusting, according to the number of occurrences, the importance value of the historical memory object.

Specifically, repeated IMOs may appear in the historical conversation database. For the repeated IMOs, the number of occurrences of the IMOs in the historical conversation database may be determined. The importance value of the IMO may be determined or adjusted based on the number of occurrences. For example, the more the number of occurrences, the higher the importance value.

After the importance value of IMO is determined according to the sentence structure, the importance value may be adjusted according to the number of occurrences. A weighted sum calculation may also be performed according to the grammatical structure and the number of occurrences to obtain the importance value of IMO.

The beneficial effect of such a setting is that the number of occurrences may increase the importance value of the IMO, so that when selecting the target memory object, the IMO with a higher number of occurrences may be preferentially selected, which is conducive to meeting actual needs of the user and improving the user experience.

In this embodiment, the determining, according to the distance value, the correlation value, and the importance value corresponding to the historical memory object, the association value between the historical memory object and the current conversation information, includes: performing a weighted processing on the distance value, the correlation value, and the importance value corresponding to the historical memory object, and determining a weighted processing result as the association value between the historical memory object and the current conversation information.

Specifically, for these three indicators of the distance value, the correlation value, and the importance value, a weight may be set according to actual needs or preset rules. After the distance value, the correlation value, and the importance value of the IMO are obtained, the weighted processing may be performed according to a preset weight of these three indicators. For example, the weighted sum calculation may be performed. A calculation result after the weighted processing is determined, and the calculation result is determined as the association value between the IMO and the current conversation information.

The beneficial effect of such a setting is that these three indicators are comprehensively considered to improve the accuracy of determining the association value, thereby improving the accuracy of determining the response information.
S203, determine, according to the association value corresponding to the each historical memory object, the target memory object from the historical conversation database.

For example, after the association value of each IMO is obtained, the target memory object may be determined from the historical conversation database according to a magnitude of each association value. For example, the IMO with a largest association value may be determined as the target memory object.

In this embodiment, for each IMO, the association value with the current conversation information may be calculated, so as to find the historical conversation information with a strongest association, assist in responding to the current conversation information, improve the accuracy of human-computer interaction, and improve the user experience.
S204, determine, according to the target memory object, response information of the current conversation information.

For example, this step may refer to the above-mentioned step S103 and will not be repeated.

In the embodiment of the present disclosure, when a user is performing human-computer interaction, current conversation information and a historical conversation database may be acquired in real time. The historical conversation database may include a plurality of historical memory objects, each historical memory object may represent historical conversation information of the user and a timestamp and semantic information and other analysis results of the historical conversation information. For each piece of historical conversation information, a separate historical memory object is generated for storage. According to the analysis result of the historical memory object, the historical memory object associated with the current conversation information is determined from the historical conversation database as the target memory object. The user is responded to in combination with the target memory object. By generating the historical memory object, an interception of a long historical conversation is reduced, a memory capacity is improved, and historical information related to a current conversation may be retrieved more accurately, thereby improving accuracy and efficiency of human-computer interaction and improving the user's interactive experience.

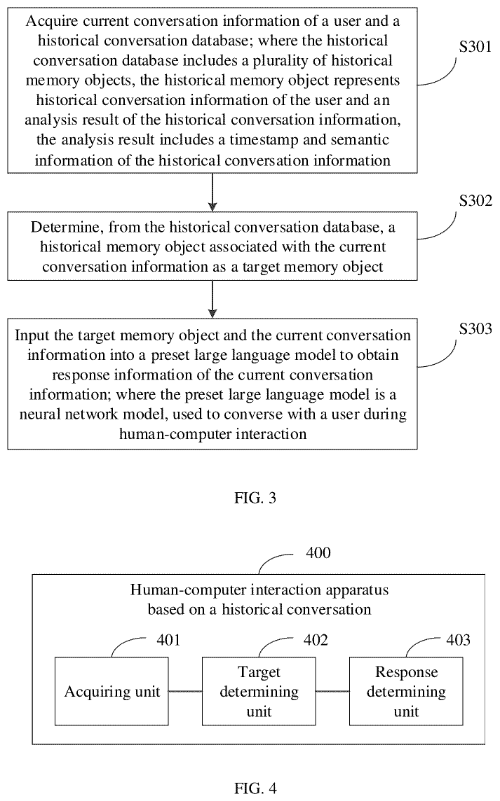

FIG. 3 is a flow schematic diagram of a human-computer interaction method based on a historical conversation according to an embodiment of the present disclosure.

In this embodiment, determining, according to a target memory object, response information of current conversation information, includes: inputting the target memory object and the current conversation information into a preset large language model to obtain the response information of the current conversation information; where the preset large language model is a neural network model, used to converse with a user during human-computer interaction.

As shown in FIG. 3, the method includes the following steps:
S301, acquire the current conversation information of a user and a historical conversation database; where the historical conversation database includes a plurality of historical memory objects, the historical memory object represents the historical conversation information of the user and an analysis result of the historical conversation information, the analysis result includes a timestamp and semantic information of the historical conversation information.

For example, this step may refer to the above-mentioned step S101 and will not be repeated.
S302, determine, from the historical conversation database, a historical memory object associated with the current conversation information as a target memory object.

For example, this step may refer to the above-mentioned step S102 and will not be repeated.
S303, input the target memory object and the current conversation information into the preset large language model to obtain the response information of the current conversation information; where the preset large language model is the neural network model, used to converse with the user during the human-computer interaction.

For example, an LLM model is preset. After the target memory object is obtained, the target memory object and the current conversation information may be input into a preset LLM model, and the LLM model outputs the response information of the current conversation information. The LLM model is a pre-built and trained neural network model, which may be used to converse with the user during the human-computer interaction and respond to questions raised by the user. In this embodiment, a model structure of the LLM is not specifically limited.

For example, a prompt of the LLM model may be generated according to the target memory object and the current conversation information. The LLM performs semantic analysis on the prompt, and may also refer to a context of the current conversation information to obtain the response information of the current conversation information. For example, the current conversation information is “What is a route to community A?”, but there is a community A in a city B and a community A in a city C. If the historical conversation information in the target memory object mentions the community A in the city B, then the response information may be the route to the community A in the city B.

In this embodiment, the large language model may combine the current conversation information and the target memory object to automatically generate response information, and the LLM may more accurately understand the user's intention by using the target memory object, so as to improve a response quality, and improve user experience.

In the embodiment of the present disclosure, when a user is performing human-computer interaction, current conversation information and a historical conversation database may be acquired in real time. The historical conversation database may include the plurality of historical memory objects, each historical memory object may represent historical conversation information of the user and a timestamp and semantic information and other analysis results of the historical conversation information. For each piece of historical conversation information, a separate historical memory object is generated for storage. According to the analysis result of the historical memory object, the historical memory object associated with the current conversation information is determined from the historical conversation database as the target memory object. The user is responded to in combination with the target memory object. By generating the historical memory object, an interception of a long historical conversation is reduced, a memory capacity is improved, and historical information related to a current conversation may be retrieved more accurately, thereby improving accuracy and efficiency of human-computer interaction and improving user's interactive experience.

FIG. 4 is a structural block diagram of a human-computer interaction apparatus based on a historical conversation according to an embodiment of the present disclosure. For ease of explanation, only the parts related to the embodiment of the present disclosure are shown. Referring to FIG. 4, a human-computer interaction apparatus 400 based on historical conversation includes: an acquiring unit 401, a target determining unit 402, and a response determining unit 403.

The acquiring unit 401 is configured to acquire current conversation information of a user and a historical conversation database; where the historical conversation database includes a plurality of historical memory objects, the historical memory object represents historical conversation information of the user and an analysis result of the historical conversation information, the analysis result includes a timestamp and semantic information of the historical conversation information;
the target determining unit 402 is configured to determine, from the historical conversation database, a historical memory object associated with the current conversation information as a target memory object;
the response determining unit 403 is configured to determine, according to the target memory object, response information of the current conversation information.

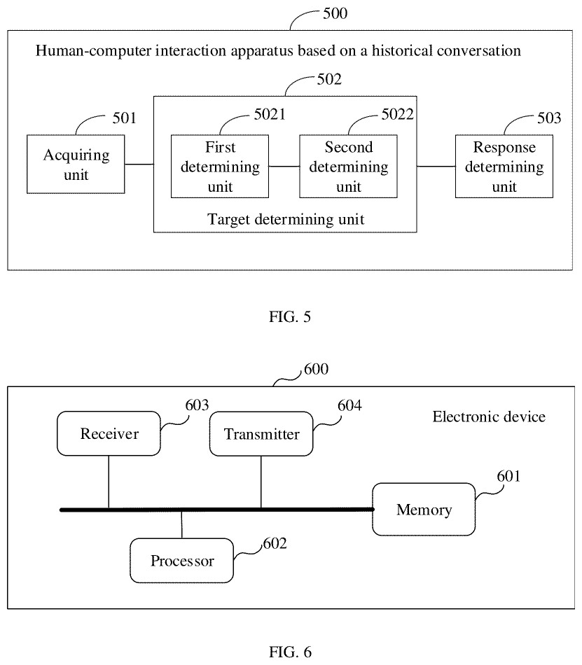

FIG. 5 is a structural block diagram of a human-computer interaction apparatus based on historical conversation according to an embodiment of the present disclosure. As shown in FIG. 5, the human-computer interaction apparatus 500 based on historical conversation includes an acquiring unit 501, a target determining unit 502 and a response determining unit 503, where the target determining unit 502 includes a first determining module 5021 and a second determining module 5022.

The first determining module 5021 is configured to determine an association value between each historical memory object and current conversation information in a historical conversation database; where the association value represents an association degree between a historical memory object and the current conversation information;
the second determining module 5022 is configured to determine, according to the association value corresponding to the each historical memory object, a target memory object from the historical conversation database.

In one example, the first determining module 5021 includes:
a first determining submodule, configured to determine, according to a timestamp of the historical memory object, a distance value between the historical memory object and the current conversation information; where the distance value represents a time distance between the historical memory object and the current conversation information;
a second determining submodule, configured to determine, according to semantic information of the historical memory object, a correlation value between the historical memory object and the current conversation information; where the correlation value represents a semantic correlation degree between historical conversation information represented by the historical memory object and the current conversation information;
a third determining submodule, configured to determine, according to the distance value and the correlation value corresponding to the historical memory object, the association value between the historical memory object and the current conversation information.

In one example, the semantic information includes a sentiment tag, and the sentiment tag represents an emotion expressed by the historical conversation information represented by the historical memory object; the second determining submodule is specifically configured to:
perform sentiment analysis on the current conversation information to obtain sentiment information of the current conversation information;
determine a similarity between the sentiment information of the current conversation information and the sentiment tag of the historical memory object;
determine, according to the similarity, the correlation value between the historical memory object and the current conversation information.

In one example, the third determining submodule is specifically configured to:
determine a sentence structure of the historical conversation information represented by the historical memory object; where the sentence structure represents grammar and a word order of the historical conversation information;
determine an importance value of the historical memory object according to the sentence structure; where the importance value represents a degree of grammatical fluency and a degree of contextual importance of the historical conversation information represented by the historical memory object;
determine, according to the distance value, the correlation value, and the importance value corresponding to the historical memory object, the association value between the historical memory object and the current conversation information.

In one example, the apparatus further includes:
a number determining unit, configured to determine the number of occurrences of the historical conversation information represented by the historical memory object in the historical conversation database;
an importance value adjusting unit, configured to adjust, according to the number of occurrences, the importance value of the historical memory object.

In one example, the third determining submodule is specifically configured to:
perform a weighted processing on the distance value, the correlation value, and the importance value corresponding to the historical memory object, and determine a weighted processing result as the association value between the historical memory object and the current conversation information.

In one example, the apparatus further includes:
a timestamp determining unit, configured to determine a sending time of the current conversation information, and determine the sending time as a timestamp of the current conversation information;
a semantic determining unit, configured to perform a semantic analysis processing on the current conversation information to obtain semantic information of the current conversation information;
a result determining unit, configured to determine the timestamp of the current conversation information and the semantic information of the current conversation information as an analysis result of the current conversation information;
a storing unit, configured to determine the current conversation information and the analysis result of the current conversation information as a new historical memory object, and store the new historical memory object in the historical conversation database.

In one example, the apparatus further includes:
a conversation determining unit, configured to determine, in the historical conversation database, a previous piece of conversation information of the current conversation information;
an identifier adding unit, configured to mark a preset logical identifier in the current conversation information and the previous piece of conversation information of the current conversation information; where the preset logical identifier represents that there is a logical structure and a time sequence between two pieces of conversation information.

In one example, the response determining unit 503 includes:
a model response module, configured to input the target memory object and the current conversation information into a preset large language model to obtain the response information of the current conversation information; where the preset large language model is a neural network model, used to converse with the user during human-computer interaction.

In one example, the apparatus further includes:
a timestamp acquiring unit, configured to acquire, according to a preset information updating period, the timestamp of the historical memory object in the historical conversation database;
a database updating unit, configured to if it is determined that a storage duration of the historical memory object in the historical conversation database exceeds a preset duration threshold according to the timestamp of the historical memory object, delete the historical memory object from the historical conversation database.

FIG. 6 is a structural block diagram of an electronic device according to an embodiment of the present disclosure. As shown in FIG. 6, the electronic device 600 includes: at least one processor 602; and a memory 601 that is communicatively connected to the at least one processor 602; where the memory stores instructions that may be executed by the at least one processor 602, and the instructions are executed by the at least one processor 602 to cause the at least one processor 602 to execute the human-computer interaction method based on historical conversation of the present disclosure.

The electronic device 600 further includes a receiver 603 and a transmitter 604. The receiver 603 is used to receive the instructions and data sent by other devices, and the transmitter 604 is used to send the instructions and the data to external devices.

According to an embodiment of the present disclosure, the present disclosure further provides an electronic device, a readable storage medium and a computer program product.

According to an embodiment of the present disclosure, the present disclosure further provides a computer program product, including: a computer program, the computer program is stored in a readable storage medium, at least one processor of an electronic device may read the computer program from the readable storage medium, and the at least one processor executes the computer program to cause the electronic device to execute the solution provided by any of the above embodiments.

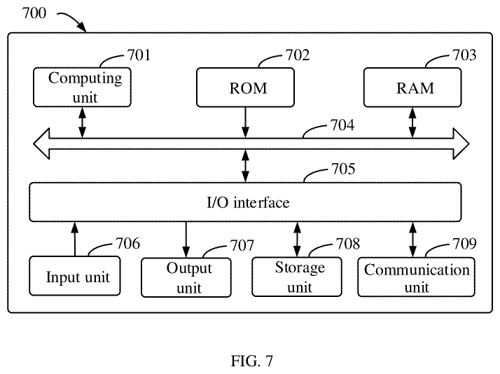

FIG. 7 shows a schematic block diagram of an example electronic device 700 that may be used to implement an embodiment of the present disclosure. The electronic device aims at digital computers representing various forms, such as a laptop computer, a desktop computer, a workbench, a personal digital assistant, a server, a blade server, a mainframe computer, and other suitable computers. The electronic device may also represent various forms of mobile devices, such as a personal digital assistant, a cellular phone, a smart phone, a wearable device, and other similar computing apparatuses. The components shown herein, their connections and relationships, and their functions are merely examples and are not intended to limit the implementation of the present disclosure described and/or required herein.

As shown in FIG. 7, the device 700 includes a computing unit 701, which may perform various appropriate actions and processes according to computer programs stored in a read-only memory (ROM) 702 or computer programs loaded from a storage unit 708 into a random access memory (RAM) 703. In the RAM 703, various programs and data required for an operation of the device 700 may also be stored. The computing unit 701, the ROM 702, and the RAM 703 are connected to each other via a bus 704. An input/output (I/O) interface 705 is also connected to the bus 704.

A number of components in the device 700 are connected to the I/O interface 705, including: an input unit 706, such as a keyboard, a mouse, etc.; an output unit 707, such as various types of displays, speakers, etc.; the storage unit 708, such as a disk, an optical disk, etc.; and a communication unit 709, such as a network card, a modem, a wireless communication transceiver, etc. The communication unit 709 allows the device 700 to exchange information/data with other devices through a computer network such as the Internet and/or various telecommunication networks.

The computing unit 701 may be a variety of general and/or special processing components with processing and computing capabilities. Some examples of the computing unit 701 include, but are not limited to, a central processing unit (CPU), a graphics processing unit (GPU), various dedicated artificial intelligence (AI) computing chips, various computing units running machine learning model algorithms, digital signal processors (DSPs), and any appropriate processors, controllers, microcontrollers, etc. The computing unit 701 performs the various methods and processes described above, such as a human-computer interaction method based on a historical conversation. For example, in some embodiments, the human-computer interaction method based on the historical conversation may be implemented as computer software programs, which are tangibly contained in a machine readable medium, such as the storage unit 708. In some embodiments, part or all of the computer programs may be loaded and/or installed on the device 700 via the ROM 702 and/or the communication unit 709. When the computer programs are loaded into the RAM 703 and executed by the computing unit 701, one or more steps of the human-computer interaction method based on the historical conversation described above may be performed. Alternatively, in other embodiments, the computing unit 701 may be configured to execute the human-computer interaction method based on the historical conversation in any other appropriate manner (e.g., by means of firmware).

Various implementations of the system and technology described above herein may be implemented in digital electronic circuit systems, integrated circuit systems, field programmable gate arrays (FPGA), application specific integrated circuits (ASIC), application specific standard parts (ASSP), system-on-chips (SOC), complex programmable logic devices (CPLD), computer hardware, firmware, software, and/or a combination thereof. These various implementations may include: being implemented in one or more computer programs, where the one or more computer programs may be executed and/or interpreted on a programmable system including at least one programmable processor. The programmable processor may be a special-purpose or general-purpose programmable processor, can receive data and instructions from a storage system, at least one input apparatus and at least one output apparatus, and transmit the data and instructions to the storage system, the at least one input apparatus and the at least one output apparatus.

Program codes for implementing a method of the present disclosure can be written in one programming language or any combination of a plurality of programming languages. These program codes can be provided to a processor or a controller of a general-purpose computer, a special-purpose computer, or other programmable data processing apparatus, so that functions/operations specified in flowcharts and/or block diagrams are implemented when the program codes are executed by the processor or the controller. The program codes may be executed entirely on a machine, partly on a machine, as an independent software package, partly executed on a machine and partly executed on a remote machine, or entirely executed on a remote machine or a server.

In the context of the present disclosure, the machine-readable medium may be a tangible medium, which may contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductive system, apparatus, or device, or any suitable combination of the foregoing. More specific examples of the machine-readable storage medium would include an electrically connected portable computer disk based on one or more wires, a hard disk, a RAM, a ROM, an erasable programmable read-only memory (EPROM or flash memory), an optical fiber, a compact disk read-only memory (CD-ROM), an optical storage device, a magnetic storage device, or any suitable combination of the foregoing.

In order to provide interaction with users, the system and technology described herein can be implemented on a computer, where the computer has: a display apparatus for displaying information to users (for example, a CRT (cathode ray tube) or LCD (liquid crystal display) monitor); and a keyboard and a pointing apparatus (for example, a mouse or a trackball) through which the user can provide inputs to the computer. Other kinds of apparatuses may also be used to provide interaction with the user, for example, the feedback provided to the user may be any form of sensory feedback (for example, visual feedback, auditory feedback, or tactile feedback); and may receive inputs from the user in any form (including acoustic inputs, voice inputs, or tactile inputs).

The system and technology described herein can be implemented in a computing system that includes background components (for example, as a data server), or a computing system that includes middleware components (for example, an application server), or a computing system that includes front-end components (for example, a user computer with a graphical user interface or a web browser through which the user can interact with implementations of the system and technology described herein), or a computing system that includes any combination of such background components, middleware components or front-end components. The components of the system can be connected to each other through digital data communication in any form or medium (for example, a communication network). Examples of the communication network include: a local area network (LAN), a wide area network (WAN) and the Internet.

A computer system may include a client and a server. The client and server are generally remote from each other and usually interact through a communication network. A relationship between the client and the server is generated through computer programs running on corresponding computers and having a client-server relationship with each other. The server may be a cloud server, also known as a cloud computing server or a cloud host, which is a host product in a cloud computing service system to overcome defects of huge management difficulty and weak business scalability existing in a traditional physical host and a Virtual Private Server (VPS). The server may also be a server of a distributed system, or a server combined with a blockchain.

It should be understood that various forms of processes shown above may be used to reorder, add or delete steps. For example, the steps described in the present disclosure may be executed in parallel, sequentially or in a different order, as long as a desired result of the technical solution disclosed in the present disclosure can be achieved, and there is no limitation herein.

The aforementioned specific implementations do not constitute a limitation to the protection scope of the present disclosure. It should be understood by those skilled in the art that various modifications, combinations, sub-combinations and substitutions may be performed according to design requirements and other factors. Any modification, equivalent replacement, improvement and the like made within the spirit and principle of the present disclosure shall be included in the protection scope of the present disclosure.

What is claimed is:

1. A human-computer interaction method based on a historical conversation, comprising:
acquiring current conversation information of a user and a historical conversation database; wherein the historical conversation database comprises a plurality of historical memory objects, the historical memory object represents historical conversation information of the user and an analysis result of the historical conversation information, the analysis result comprises a timestamp and semantic information of the historical conversation information;
determining, from the historical conversation database, a historical memory object associated with the current conversation information as a target memory object;
determining, according to the target memory object, response information of the current conversation information.

2. The method according to claim 1, wherein the determining, from the historical conversation database, the historical memory object associated with the current conversation information as the target memory object comprises:
determining an association value between each historical memory object and the current conversation information in the historical conversation database; wherein the association value represents an association degree between the historical memory object and the current conversation information;
determining, according to the association value corresponding to the each historical memory object, the target memory object from the historical conversation database.

3. The method according to claim 2, wherein the determining the association value between the each historical memory object and the current conversation information in the historical conversation database comprises:
determining, according to a timestamp of the historical memory object, a distance value between the historical memory object and the current conversation information; wherein the distance value represents a time distance between the historical memory object and the current conversation information;
determining, according to semantic information of the historical memory object, a correlation value between the historical memory object and the current conversation information; wherein the correlation value represents a semantic correlation degree between the historical conversation information represented by the historical memory object and the current conversation information;
determining, according to the distance value and the correlation value corresponding to the historical memory object, the association value between the historical memory object and the current conversation information.

4. The method according to claim 3, wherein the semantic information comprises a sentiment tag, and the sentiment tag represents an emotion expressed by the historical conversation information represented by the historical memory object; and the determining, according to the semantic information of the historical memory object, the correlation value between the historical memory object and the current conversation information comprises:
performing sentiment analysis on the current conversation information to obtain sentiment information of the current conversation information;
determining a similarity between the sentiment information of the current conversation information and the sentiment tag of the historical memory object;
determining, according to the similarity, the correlation value between the historical memory object and the current conversation information.

5. The method according to claim 3, wherein the determining, according to the distance value and the correlation value corresponding to the historical memory object, the association value between the historical memory object and the current conversation information comprises:
determining a sentence structure of the historical conversation information represented by the historical memory object; wherein the sentence structure represents grammar and a word order of the historical conversation information;
determining an importance value of the historical memory object according to the sentence structure; wherein the importance value represents a degree of grammatical fluency and a degree of contextual importance of the historical conversation information represented by the historical memory object;
determining, according to the distance value, the correlation value, and the importance value corresponding to the historical memory object, the association value between the historical memory object and the current conversation information.

6. The method according to claim 5, further comprising:
determining a number of occurrences of the historical conversation information represented by the historical memory object in the historical conversation database;
adjusting, according to the number of occurrences, the importance value of the historical memory object.

7. The method according to claim 6, wherein the determining, according to the distance value, the correlation value, and the importance value corresponding to the historical memory object, the association value between the historical memory object and the current conversation information comprises:
performing a weighted processing on the distance value, the correlation value, and the importance value corresponding to the historical memory object, and determining a weighted processing result as the association value between the historical memory object and the current conversation information.

8. The method according to claim 1, further comprising:
determining a sending time of the current conversation information, and determining the sending time as a timestamp of the current conversation information;
performing a semantic analysis processing on the current conversation information to obtain semantic information of the current conversation information;
determining the timestamp of the current conversation information and the semantic information of the current conversation information as an analysis result of the current conversation information;
determining the current conversation information and the analysis result of the current conversation information as a new historical memory object, and storing the new historical memory object in the historical conversation database.

9. The method according to claim 8, further comprising:
determining, in the historical conversation database, a previous piece of conversation information of the current conversation information;
marking a preset logical identifier in the current conversation information and the previous piece of conversation information of the current conversation information; wherein the preset logical identifier represents that there is a logical structure and a time sequence between two pieces of conversation information.

10. The method according to claim 1, wherein the determining, according to the target memory object, the response information of the current conversation information comprises:
inputting the target memory object and the current conversation information into a preset large language model to obtain the response information of the current conversation information; wherein the preset large language model is a neural network model, used to converse with the user during human-computer interaction.

11. The method according to claim 1, further comprising:
acquiring, according to a preset information updating period, the timestamp of the historical memory object in the historical conversation database;
if it is determined that a storage duration of the historical memory object in the historical conversation database exceeds a preset duration threshold according to the timestamp of the historical memory object, deleting the historical memory object from the historical conversation database.

12. A human-computer interaction apparatus based on a historical conversation, comprising:
at least one processor; and
a memory communicatively connected to the at least one processor; wherein,
the memory stores instructions that are executed by the at least one processor, and the instructions are executed by the at least one processor to:
acquire current conversation information of a user and a historical conversation database; wherein the historical conversation database comprises a plurality of historical memory objects, the historical memory object represents historical conversation information of the user and an analysis result of the historical conversation information, the analysis result comprises a timestamp and semantic information of the historical conversation information;
determine, from the historical conversation database, a historical memory object associated with the current conversation information as a target memory object;
determine, according to the target memory object, response information of the current conversation information.

13. The apparatus according to claim 12, wherein the at least one processor is further configured to:
determine an association value between each historical memory object and the current conversation information in the historical conversation database; wherein the association value represents an association degree between the historical memory object and the current conversation information;
determine, according to the association value corresponding to the each historical memory object, the target memory object from the historical conversation database.

14. The apparatus according to claim 13, wherein the at least one processor is further configured to:
determine, according to a timestamp of the historical memory object, a distance value between the historical memory object and the current conversation information; wherein the distance value represents a time distance between the historical memory object and the current conversation information;
determine, according to semantic information of the historical memory object, a correlation value between the historical memory object and the current conversation information; wherein the correlation value represents a semantic correlation degree between the historical conversation information represented by the historical memory object and the current conversation information;
determine, according to the distance value and the correlation value corresponding to the historical memory object, the association value between the historical memory object and the current conversation information.

15. The apparatus according to claim 14, wherein the semantic information comprises a sentiment tag, and the sentiment tag represents an emotion expressed by the historical conversation information represented by the historical memory object; the at least one processor is specifically configured to:
perform sentiment analysis on the current conversation information to obtain sentiment information of the current conversation information;
determine a similarity between the sentiment information of the current conversation information and the sentiment tag of the historical memory object;
determine, according to the similarity, the correlation value between the historical memory object and the current conversation information.

16. The apparatus according to claim 14, wherein the at least one processor is specifically configured to:
determine a sentence structure of the historical conversation information represented by the historical memory object; wherein the sentence structure represents grammar and a word order of the historical conversation information;
determine an importance value of the historical memory object according to the sentence structure; wherein the importance value represents a degree of grammatical fluency and a degree of contextual importance of the historical conversation information represented by the historical memory object;
determine, according to the distance value, the correlation value, and the importance value corresponding to the historical memory object, the association value between the historical memory object and the current conversation information.

17. The apparatus according to claim 16, wherein the at least one processor is further configured to:
determine a number of occurrences of the historical conversation information represented by the historical memory object in the historical conversation database;
adjust, according to the number of occurrences, the importance value of the historical memory object.

18. The apparatus according to claim 17, wherein the at least one processor is specifically configured to:
perform a weighted processing on the distance value, the correlation value, and the importance value corresponding to the historical memory object, and determine a weighted processing result as the association value between the historical memory object and the current conversation information.

19. The apparatus according to claim 12, wherein the at least one processor is specifically configured to:
determine a sending time of the current conversation information, and determine the sending time as a timestamp of the current conversation information;
perform a semantic analysis processing on the current conversation information to obtain semantic information of the current conversation information;
determine the timestamp of the current conversation information and the semantic information of the current conversation information as an analysis result of the current conversation information;
determine the current conversation information and the analysis result of the current conversation information as a new historical memory object, and store the new historical memory object in the historical conversation database.

20. A non-transitory computer readable storage medium, having computer instructions stored therein, wherein the computer instructions are used to cause a computer to:
acquire current conversation information of a user and a historical conversation database; where the historical conversation database includes a plurality of historical memory objects, the historical memory object represents historical conversation information of the user and an analysis result of the historical conversation information, the analysis result includes a timestamp and semantic information of the historical conversation information;
determine, from the historical conversation database, a historical memory object associated with the current conversation information as a target memory object;
determine, according to the target memory object, response information of the current conversation information.
